(19) United States
(12) Patent Application Publication
(10) Pub. No.: US 2002/0028057 A1
(43) Pub. Date: Mar. 7, 2002

(54) Two-dimentional fiber array and method of manufacture

(76) Inventors: Mindaugas F. Dautartas, Blacksburg, VA (US); Dan A. Steinberg, Blacksburg, VA (US)

Correspondence Address: JONES VOLENTINE, L.L.C., SUITE 150, 12200 SUNRISE VALLEY DRIVE, RESTON, VA, 20191, US

(21) Appl. No.: 09/884,428

(22) Filed: Jun. 19, 2001

Related U.S. Application Data
(60) Provisional application No. 60/212,591, filed on Jun. 19, 2000.

(51) Int. Cl. G02B 6/04; G02B 6/00

(52) U.S. Cl. 385/139; 385/114; 385/115

(57) ABSTRACT

A method for fabricating an at least one optical fiber array includes planarizing an endface of at least one optical fiber and inserting an endface of the at least one optical fiber in a tool. The at least one optical fiber is then secured in the tool, and at least a portion of the tool is removed exposing the endface of the at least one optical fiber. The resultant product has significant planarity, and enables the endfaces of the optical fiber of the optical fiber arrays to be substantially coplanar.

### CROSS-REFERENCE TO RELATED APPLICATIONS

The present application claims priority from U.S. Provisional patent application Serial No. 60/212,591, filed Jun. 19, 2000, entitled “Method For Making 2-D Fiber Arrays.” The present application is related to U.S. patent application Ser. No. (Atty. Docket No. ACT.007) entitled “Method of Fabricating an Optical Fiber Array Using Photosensitive Material,” filed on even date herewith. The disclosure of this above captioned provisional patent application is specifically incorporated by reference though reproduced in its entirety herein.

### FIELD OF THE INVENTION

The present invention relates generally to optical waveguide communications, and particularly to a method of fabricating accurate two-dimensional fiber arrays.

### BACKGROUND OF THE INVENTION

The increasing demand for high-speed voice and data communications has led to an increased reliance on optical communications, particularly optical fiber communications. The use of optical signals as a vehicle to carry channeled information at high speeds is preferred in many instances to carrying channeled information at other electromagnetic wavelengths/frequencies in media such as microwave transmission lines, co-axial cable lines and twisted pair transmission lines. Advantages of optical media are, among others, high-channel capacity (bandwidth), greater immunity to electromagnetic interference, and lower propagation loss. In fact, it is common for high-speed optical communication systems to have signal rates in the range of approximately several Giga bits per second (Gbit/sec) to approximately several tens of Gbit/sec.

One way of carrying information in an optical communication system, for example an optical network, is via an array of optical fibers. Ultimately, the optical fiber ribbon may be coupled to another array of waveguides, such as another optical fiber ribbon, or a waveguide array of an optoelectronic integrated circuit (OEIC). In order to assure the accuracy of the coupling of the fiber ribbon to another waveguide array, it becomes important to accurately position each optical fiber in the array.

One technique to carry out the alignment between a fiber ribbon and another waveguide array is by active alignment followed by bonding. While the accuracy of such a technique may be acceptable, the active alignment techniques are difficult, labor intensive and expensive; and thus are not well suited for large-scale manufacturing.

In view of the drawbacks of active alignment, other techniques for aligning a fiber ribbon for accurate optical coupling have been developed, with mixed results. One such technique is the use of a high-precision metal jig. If fabricated properly, the precision of the metal jig is generally acceptable, and eliminates a great deal of the labor intensity associated with active alignment. However, there can be indexing errors in stepping across the jig during fabrication. This of course can lead to unacceptable inaccuracy. Finally, because the metal jig has a different expansion coefficient than the silica used in optical fibers and other optical waveguides, expansion mismatch can ultimately result in poor alignment.

Silicon waferboard technology has also been used to effect passive alignment in optical fiber communication systems. While silicon waferboard has shown promise in optical fiber ribbon applications, conventional uses of silicon waferboard to passively align an array of optical fibers has also met with mixed results. The drawbacks to conventional silicon waferboard passive alignment of optical fiber ribbons include relatively large pitch between fibers, pitch inaccuracy, difficulty inserting optical fibers into eched holes, and often pin-to-pin accuracy problems in certain conventional connector structures.

Accordingly, what is needed is a technique for accurately aligning optical fibers and accurately maintaining the pitch of the fibers for further coupling to other fibers and/or optical waveguide arrays.

### SUMMARY OF THE INVENTION

The present invention is drawn to a technique for fabricating a two-dimensional optical fiber ribbon.

According to an illustrative embodiment, the method includes planarizing an endface of at least one optical fiber, inserting the at least one optical fiber into a tool and securing the at least one optical fiber. Thereafter, at least a portion of the tool is removed, exposing the endface of the at least one optical fiber.

Advantageously, the present invention enables a reduced pitch between the individual optical fibers of the fiber ribbon, and improved alignment tolerances of the individual fibers, and simpler fabrication of fiber couplers.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a top view of a fiber ribbon according to an exemplary embodiment of the present disclosure.

FIGS. 2-6 show a processing sequence according to an exemplary embodiment of the present disclosure.

FIG. 7(a) shows a planarization/polish sequence according to an exemplary embodiment of the present disclosure.

FIG. 7(b) shows a planarization/polish sequence according to an exemplary embodiment of the present disclosure.

FIG. 8 is an alternative planarization/polish step according to an exemplary embodiment of the present disclosure.

FIG. 9 is an exemplary embodiment of the present disclosure in which the optical fibers are stacked between v-groove chips.

FIG. 10 is a side view of single stick used in a stack for aligning a two-dimensional array of optical fibers in accordance with an exemplary embodiment of the present invention.

FIGS. 11-13 are an illustrative processing sequence for forming a tool in accordance with an exemplary embodiment of the present invention.

FIG. 14. is an alternative embodiment of the present invention shown in side view.

FIG. 15 is a side view of another illustrative embodiment of the present invention.

FIG. 16 is a perspective view of a v-groove stick in accordance with an illustrative embodiment of the present invention.

FIG. 17 is a top view of a wafer showing v-groove sticks patterned therefrom in accordance with an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present invention relates to a method of manufacturing an array of optical fibers which may be a linear array or a matrix array. According to exemplary embodiments of the present invention, the pitch, or the center-to-center spacing of the optical fibers, is precisely determined, and the planar or two-dimensional alignment of the fibers is accurate. Herein, examples of carrying out the invention of the present disclosure are described in further detail. In the exemplary embodiments described below, a tool is used to accurately locate the fibers of the array. The tool is optionally formed from a monocrystalline material (e.g. (100) silicon). To this end, accurately located and spaced grooves or pits are formed in the tool, and are used to secure the fibers at precise locations. The fibers are then secured and the tool is either removed or polished so that the endfaces of the fiber are exposed.

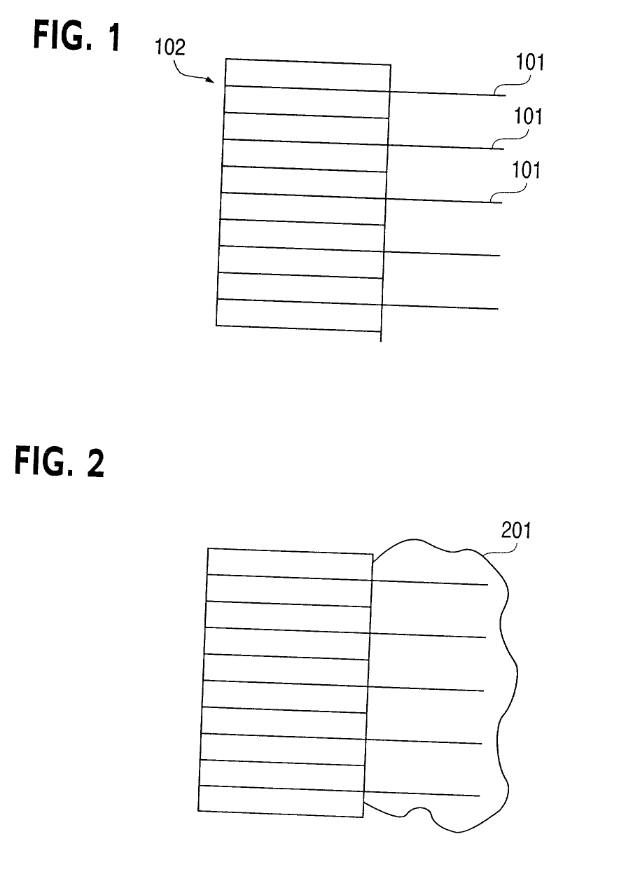

FIG. 1 is a side view of fiber ribbons 101 stacked and secured together, wherein each fiber ribbon 101 is held by an optional alignment member 102. In the illustrative embodiment of FIG. 1, the fiber ribbons 101 extend into the plane of the page. (+x-direction according to the cartesian coordinate system shown). The freestanding length of the fiber from endface 103 to the end of alignment member 102 is approximately 0.5 mm to approximately 10.0 mm. It is of interest to note that the fibers can be stripped of buffer and/or sheathing by standard technique, so that the fibers are slightly bendable. It is notes that other optical waveguides may be aligned in accordance with exemplary embodiments of the present invention. To this end, fiber ribbons 101 are merely illustrative. Other waveguides to include individual optical fibers and rows, integrated optical waveguides and rows, and polymer waveguides and rows, to name a few examples, may be aligned in accordance with exemplary embodiments of the present invention.

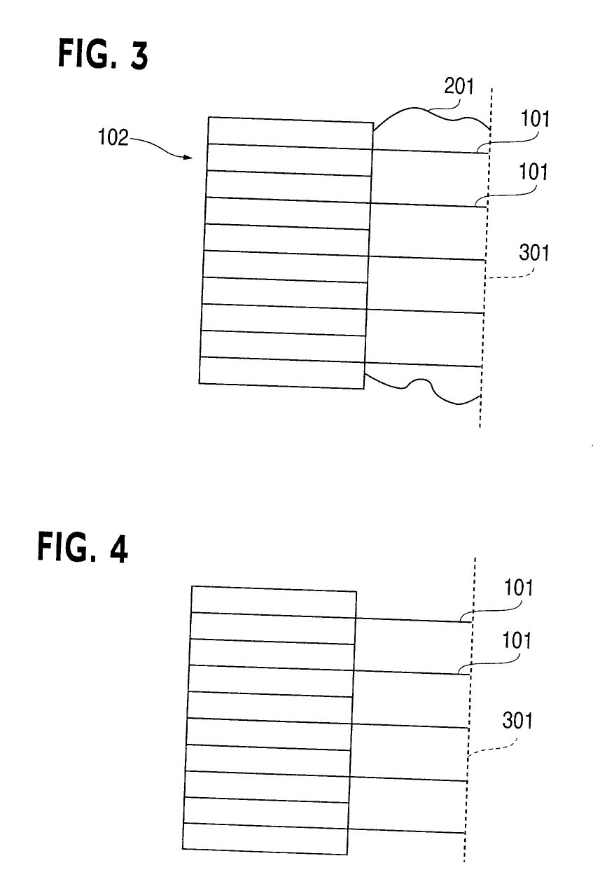

As shown in FIG. 2, the freestanding portions of the fiber are potted in a resin-material 201, which may be removable. The removable resin holds the fibers in place during a subsequent planarazation step. Illustratively, the removable resin may be wax, polymethylmethacrylate (PMMA), phenol, soluable polymers, and solder. Thereafter, as shown in FIG. 3, with the fibers of fiber ribbons 101 held securely in place with the removable resin 201, the endfaces of the fibers are simultaneously rough polished, or lapped, so that they are substantially co-planar with planarazation plane 301. The fibers of fiber ribbons 101 may be planarized while the buffer is in place. Moreover, it is possible that the resin 201 is not used and fibers are planarized to the planarization plane 301 while they are freestanding. It is of interest to note that the step of planarization shown in FIG. 3 does not necessarily provide a final polish to the endfaces of the fiber. Of course, the final polish step could be carried out at this point in the process, or subsequently thereto. Thereafter, as is shown in FIG. 4, the resin is removed, and the fibers of the fiber ribbons 101 are again freestanding. However, the fibers of the fiber ribbons 101 have substantially planar endfaces in the planarazation plane 301. It is noted that the planarization step is optional. Altemaitvely, the fibers may be stacked so that the fiber endfaces are coplanar.

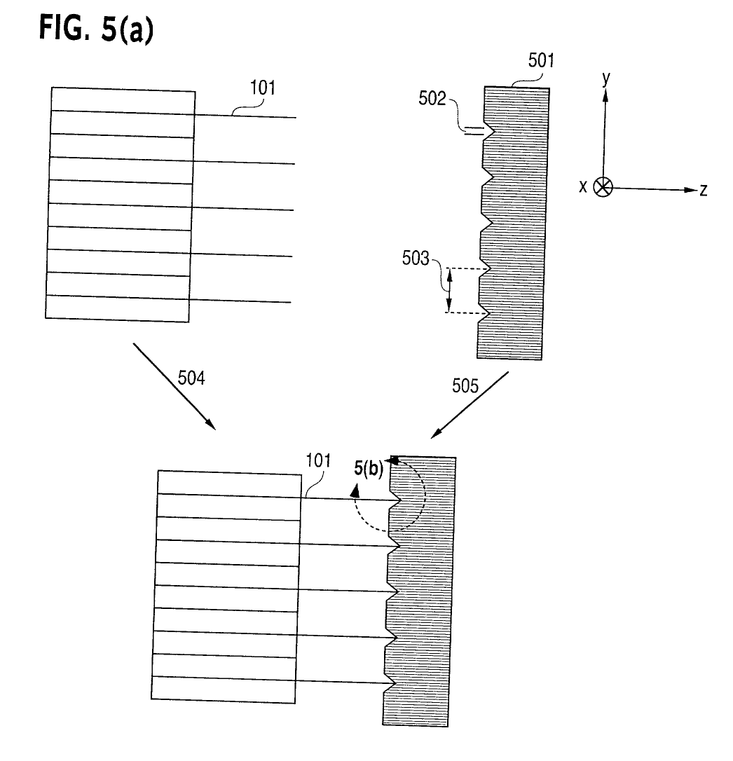

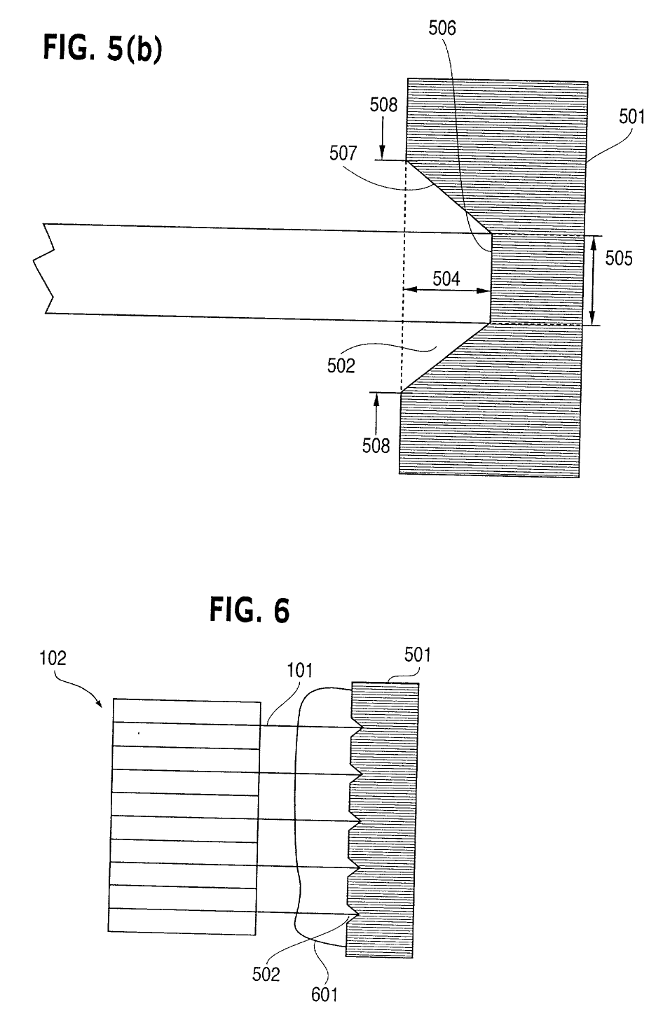

Turning now to FIGS. 5(a) and 5(b), the accurate location of the freestanding optical endfaces is carried out through the use of an alignment tool 501. Generally, the alignment tool is fabricated from a monocrystalline material (e.g. silicon) using selective etching techniques well-known to one having ordinary skill in the art. For example, a KOH solution may be used to form pits in silicon. Accordingly, preferential etching is carried out, and sidewalls 507 such as pits 502 are formed along the principal planes of the solid state material. By properly locating a mask having a defined width through sub-micron photolithic graphic techniques, the location of each pit 502 may be precisely determined. Moreover, the pitch 503 (e.g. the center-to-center spacing of the v-grooves) is also very precisely determined. Illustratively, the pitch 503 is in the range of approximately 38 μm to approximately 1000 μm. The accuracy of the pitch 503 is better than approximately 1.0 μm by virtue of the the photolithography used to make the pits 502. The selective etching of monocrystalline materials such as silicon is well-known in the art, and may be found, for example, in U.S. Pat. No. 4,210,923, to North, et al. The disclosure of this U.S. patent is specifically incorporated by reference as though reproduced in its entirety herein.

As shown at 504 and 505, the freestanding endfaces of the optical fibers of fiber ribbons 101 are positioned within the micro-machined pits 502 of alignment tool 501. The accurate placement of the optical fiber within the micro-machined pits 502 is shown in the enlarged view of FIG. 5(b). According to the exemplary embodiment of FIG. 5(b), the micro-machined pits 502 have a substantially flat bottom, although a conical shaped bottom is possible. The width 508 of the opening determines the depth 504 of the opening of the micro-machined pits. Moreover, as is described in the reference to North, et al., duration of the etch step will determine the depth 504 as well as the width 508 of the bottom 506 of the micro-machined pits 502. The flat bottom 506 assures accurate alignment of the fiber, while minimizing the chance of damage to the endface of the fiber. Illustratively, the width 509 of the bottom portion is approximately 50 μm to approximately 150 μm.

Finally, it is of interest to note that the sloping sidewalls 507 serve to guide the fiber into the pit 502 and locate the endface of the fiber with the flat bottom 506 of the micro-machined pits 502. To this end, as shown in the exemplary embodiment shown in FIGS. 5(a) and 5(b), the freestanding optical fibers of the fiber ribbons 101 are usefully aligned with sufficient accuracy so that the fiber endfaces make contact with the sloping sidewalls 507 when the tool 501 and the fiber ribbons 101 are brought together. Generally, the depth 504 of the pits 502 is approximately 20 μm to approximately 50 μm. As such, the endfaces of the fiber should be located within a certain distance of their desired position. For example, in the case that the depth 504 is 30 μm, the endfaces of fiber should be located within 20 μm of their desired position. While such relatively poor accuracy can be difficult by simply stacking fiber ribbons 101, through the process of the exemplary embodiment of the present disclosure, this is relatively simple to accomplish. Moreover, usefully, the length of freestanding portion of the fiber (i.e. the portion not in the pit 502) is at least approximately 0.5 mm. This enables the fibers to bend slightly to be positioned by the tool. The freestanding length may be in the range of approximately 0.5 mm to approximately 10.0 mm.

FIG. 6 shows the fibers of the fiber ribbons 101 secured to the tool 501 within each individual micro-machined pits 502 by a suitable adhesive 601. The adhesive 601 may be an optical grade epoxy, and may optionally extend to the alignment member 102. It is noted that solder may be substituted for epoxy as the securing material. In such a case, the optical fibers are illustratively coated with metal for suitable solder wetting.

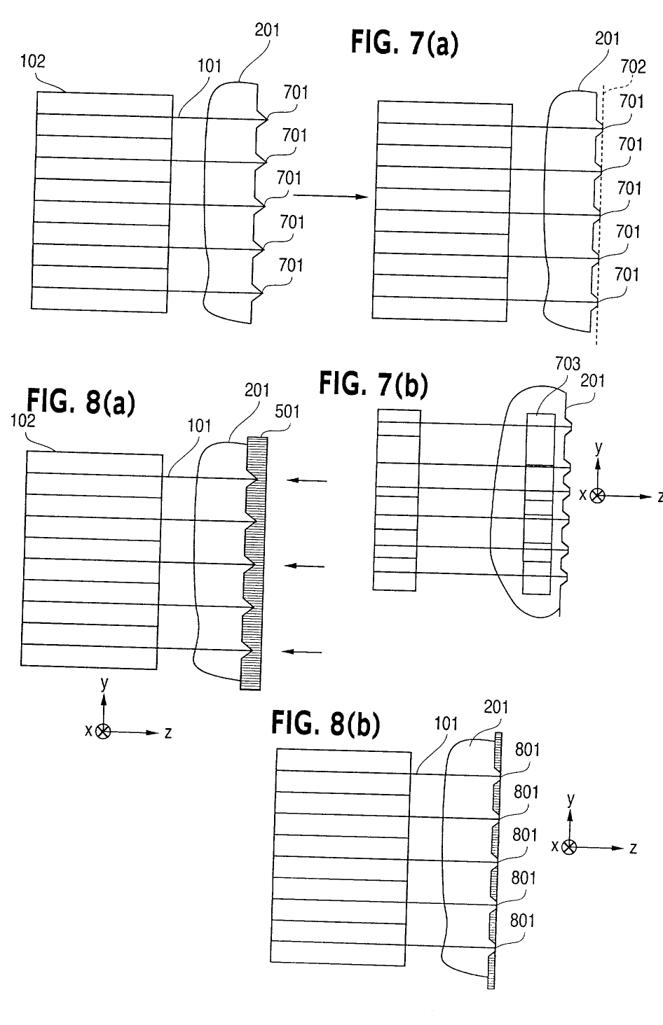

FIG. 7(a) shows an illustrative technique for effecting the finished product of the present exemplary embodiment. To this end, the tool 501 is removed, leaving the exposed fiber endfaces shown at 701. Thereafter, a standard planarazation/polish technique may be carried out to assure co-planarity of the endfaces of the fibers 701. In FIG. 7 the endfaces of the fiber are along a common plane 702 in the final version. It is noted however that the fibers could be angle polished in a uniform manner.

FIG. 7(b) shows an alternative embodiment where a rigid plate 703 is disposed in the adhesive 701. The rigid plate 703 can have holes that loosely fit the optical fibers (e.g. the holes can be approximately 135 μm to approximately 200 μm in diameter for fibers 125 μm in diameter). The rigid plate 703 can be made of silicon, metal, ceramics or the like. The rigid plate 703 tends to add structural stability and rigidity to the fiber ribbon after the tool is removed. Without the rigid plate 703, the adhesive 601 alone can be too soft or too easily deformed to be used in some applications. That is, the accurate fiber alignment in the array can be damaged by bending or deformation of the adhesive.

Alternatively, as shown in FIGS. 8(a) and 8(b) the micro-machined tool 501 may be thinned by standard techniques, including cleaving, grinding and/or polishing. It is of interest to note that cleaving, grinding and polishing may be carried out individually or in combination to thin the tool 501 so that the endfaces 801 of the fibers are exposed. As with the embodiment shown in FIG. 7, the endfaces of the fibers 801 of the fiber ribbons 101 are coplanar (e.g. in the x-y plane as shown).

FIGS. 9(a) and 9(b) show cross-sectional views of another illustrative embodiment of the present invention including a tool 901 for accurate alignment of optical fibers in an optical fiber ribbon 101. In the exemplary embodiment shown in FIG. 9a, the tool 901 receives optical fiber ribbon 101 in openings 902. The tool 901 is illustratively formed of a material that is monocrystalline. Illustratively, monocrystalline silicon (e.g. (100) silicon) may be used. As described previously, sidewalls 903 and 905 are at predetermined angles (e.g. 54.7°) due to selective etching. The relatively thin portion 904 of the tool 901 allows the wet etched holes to be placed relatively close together. To this end, the center-to-center spacing, the pitch, (of the openings 902) is in the range of approximately 150 μm to approximately 500 μm with a tolerance on the order of approximately 0.5 μm to approximately 3.0 μm. The tolerance may be in the range of approximately 0.5 μm to less than approximately 1.0 μm. It is noted that dry etching techniques (e.g., reactive ion etching (RIE)) may be used to partially fabricate tool 901.

Alternatively, as is shown in FIG. 9b, the optical fiber ribbon 101 can be oriented in openings 902. To this end, the tool 901 is etched leaving the cavity 906 as shown, with the thin portion 904 on the opposite side thereof. The maximum thickness of the thin portion 904 depends upon the desired pitch between the openings 902. To this end, due to the illustrative selective wet etching, the sidewalls 905 of openings 902 have a predetermined slope or angle as defined by the crystalline plane of the material used for the tool 901. As such, a small pitch requires a thickness on the order of approximately 5.0 μm to approximately 200 μm for the thin portion 904. This results in a center-to-center spacing of openings (and therefore, of the optical fiber ribbons 101) to be on the order of approximately 150 μm to approximately 500 μm with a tolerance on the order of approximately 0.5 μm to approximately 3.0 μm.

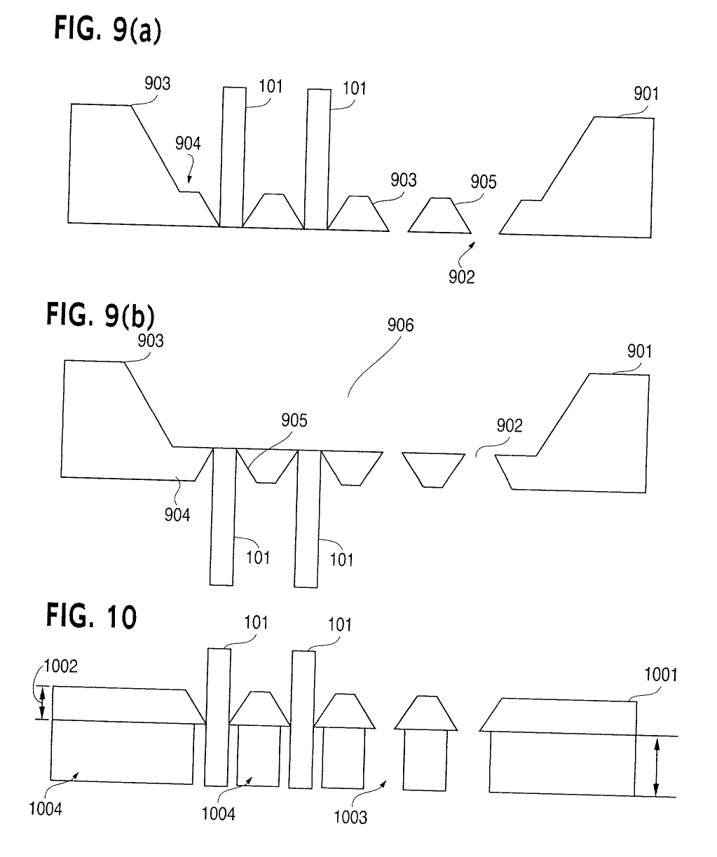

FIG. 10 shows an alternative embodiment of the alignment tool 1001. According to this illustrative embodiment, the thickness 1002 of the tool 1001 is relatively thin, fostering a reduced pitch between the holes 1003, and thereby optical fiber ribbons 101. Again, this follows relatively straightforwardly from an understanding of selective etching of monocrystalline materials. However, the thickness 1002 may be too small to rigidly support the fibers in a reliable manner. In order to fortify the tool 1001, rib members 1004 are provided. These rib members 1004 add support to the tool 1001, allowing the thickness 1002 of the tool to be made thinner. This allows for a reduced fiber pitch. Illustratively, the thickness of the rib members 1004 is on the order of at most approximately 5 to approximately 6 times the diameter of the fiber ribbon 101. By keeping the thickness of the ribs 1004 within this approximate range, potential fiber misalignment caused by fiber bending, as well as optical loses from fiber bending may be substantially avoided.

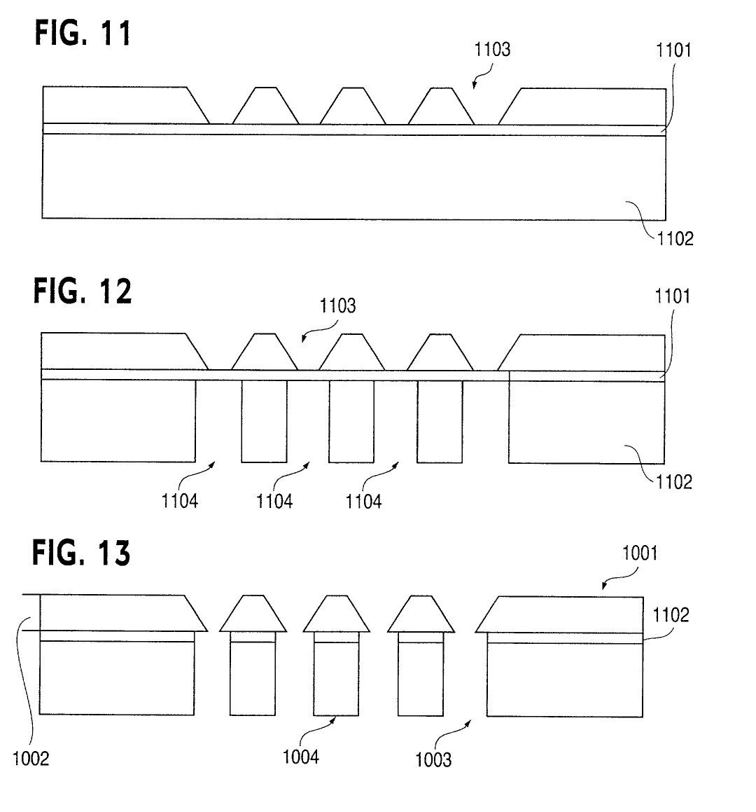

Turning to FIGS. 11-13, an exemplary fabrication sequence for forming the tool 1001 of FIG. 10 is shown. Illustratively, a layer of un-etched material such as monocrystalline silicon (not shown) is disposed on a layer of insulator 1101. This insulator layer 1101 is illustratively silicon nitride or silicon dioxide. The insulator layer 1101 is disposed on a handle layer 1102, which is illustratively silicon. Thereafter, a standard wet anisotropic etch is carried-out to form opening 1103. Thereafter, using a suitable drying etching technique, (e.g., (RIE)), portions of the handle layer 1102 are removed, forming openings 1104 opposed to openings 1103. In both the wet etch step used to form openings 1103 and the dry etch step used to make opening 1104, the layer of insulator 1101 acts as an etch stop. Next, as shown in FIG. 13, the insulator layer 1102 is removed to selectively form the tool 1001.

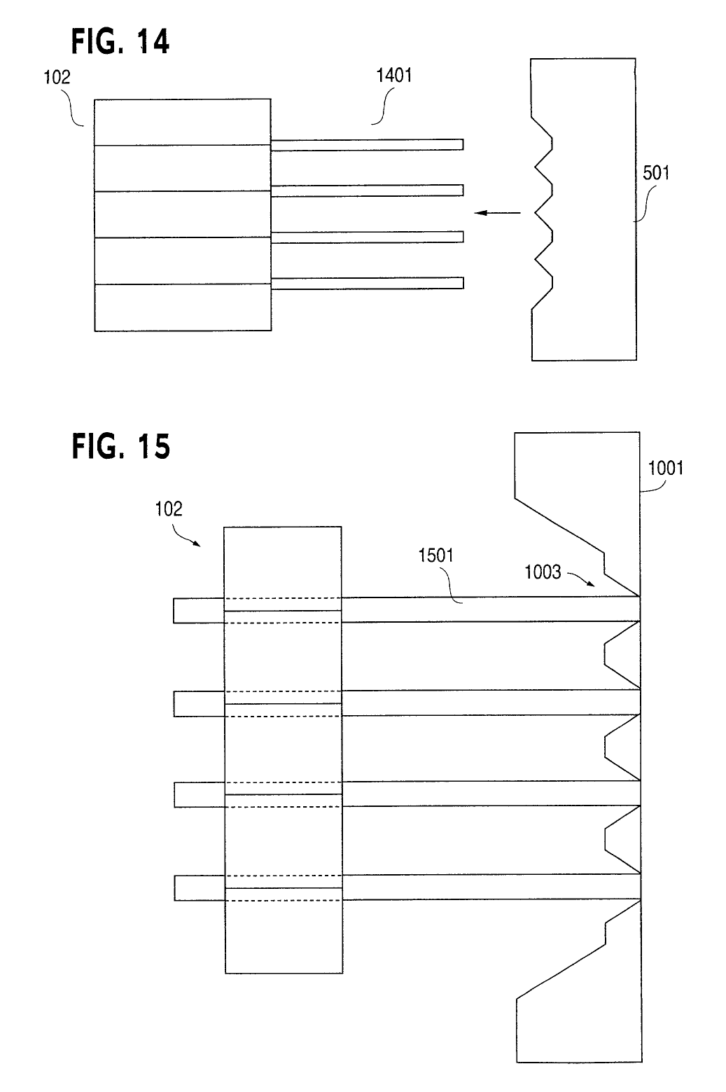

FIG. 14 shows an alternative embodiment of the present invention. In this illustrative embodiment, optical fibers 1401 may be disposed in and roughly aligned by alignment members 102. The optical fibers 1401 are in rows extending into the plane of the page. Multiple alignment members 102 may be stacked as shown. Each alignment member 102 has multiple grooves, and, thereby fiber ribbons may be roughly aligned. The alignment members 102 may have slightly different thicknesses. This results in a variation in the pitch, known as “run-out” error. While the alignment members 102 have run-out error in tall stacks (e.g. more than 2-4 alignment members 102 is a stack), the run-out error can be substantially reduced by the use of silicon waferboard having a relatively precise thickness. The precision of the wafers are on the order of approximately ±1 μm to approximately ±3 μm. According to the illustrative embodiment of FIG. 14, a stack of alignment members 102 with optical fibers 1401 extending therefrom can be used in lieu of the ribbon stack of embodiments described previously. The tool 501 may be used to effect the alignment of the optical fiber ribbon 101, with further processing to remove and/or polish the alignment tool 501 so that the endfaces of optical fiber ribbon 101 are suitably exposed. Again, further details of this fabrication sequence are as described above and in other exemplary embodiments.

Turning to FIG. 15, the alignment member 102 is shown to provide the coarse alignment for optical fibers making use of tool 1001, according to an exemplary embodiment of the present disclosure. While the tool 1001 shown in the exemplary embodiment of FIG. 15 does not include ribs (e.g. the tool of FIG. 14), clearly, one having ordinary skill in the art would recognize that the alignment members 102 would be readily adaptable for use with such a tool. The alignment member 102 holds the fibers 1501 in approximate alignment, on the order of ±10 μm to approximately ±20 μm. In this way, the fibers can be readily guided into the holes 1003 of the tool 1001. (Again, the fibers 1501 are in rows extending into the plane of the page). The holes 1003 of the tool 1001 thereby provide precise alignment. Illustratively, all of the fibers are assembled into the stack before they are inserted into the holes 1003. As described previously, the optical fibers 1001 may be planarized by standard technique so that they are substantially coplanar.

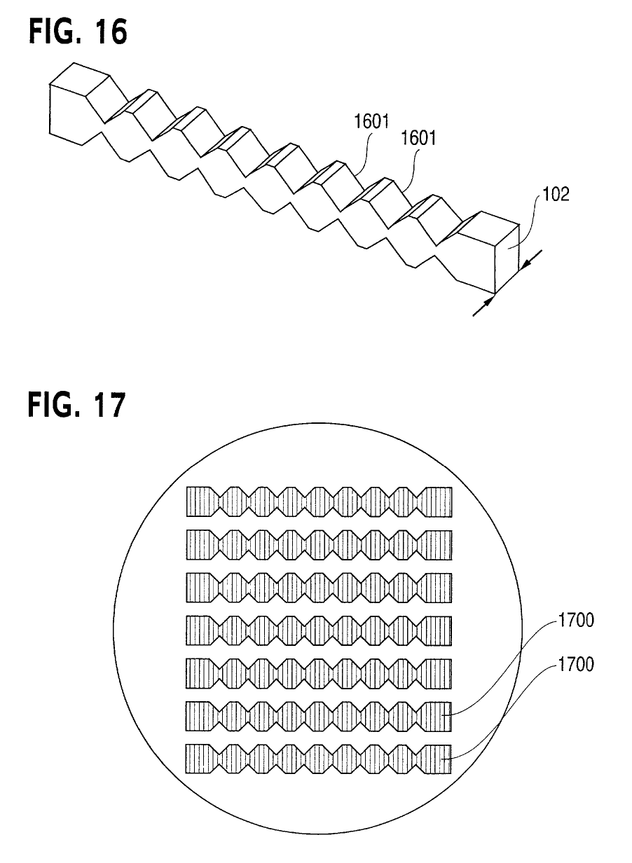

Finally, turning to FIGS. 16 and 17, a single v-groove sticks 1600 and multiple v-groove sticks 1700 masked in preparation for reactive ion etching are shown, respectively. The v-groove sticks 1600 have multiple v-grooves 1601 therein. These v-groove sticks are stacked upon one another (providing fiber alignment for use with the alignment tools 1001 or 501, for example). The fabrication of the v-groove sticks 1600 is by standard technique, well known to one having ordinary skill in the art, for example by reactive-ion-etching (RIE). Further details of v-groove sticks 1600 may be found in co-pending U.S. patent application Ser. No. 09/615,101, filed Jul. 13, 2000, entitled “2-Dimensional Optical Fiber Array Made From Etched Sticks Having Notches”; the disclosure of which is specifically incorporated by reference herein and for all purposes.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

We claim:

1. A method for fabricating an optical fiber array, the method comprising:
a) planarizing an endface of at least one optical fiber;
b) inserting said at least one optical fiber in a tool;
c) securing said at least one optical fiber in said tool; and
d) removing at least a portion of said tool, exposing said endface of said at least one optical fiber.

2. A method as recited in claim 1, wherein said at least one optical fiber is potted in a resin material prior to (a).

3. A method as recited in claim 1, wherein said tool includes at least one pit which receives said at least one optical fiber.

4. A method as recited in claim 1, wherein said at least one pit is formed along defined crystalline planes.

5. A method as recited in claim 1, wherein said tool is formed of a monocrystalline material.

6. A method as recited in claim 1, the method further comprising removing all of said tool in (d).

7. A method as recited in claim 1, wherein said tool includes a plurality of pits, each of which receives one of said optical fibers, and said pits have a pitch in the range of approximately 150 μm to approximately 1000 μm.

8. A method as recited in claim 2, wherein said resin is removed after (d.).

9. A method as recited in claim 7, wherein a plurality of sticks having notches therein are stacked to form an array of said notches, and said at least one optical fiber of said first array and said at least one optical fiber of said second array are located in said notches of said sticks.

10. A method as recited in claim 4, wherein said pits each have a substantially flat bottom, and said endface of said at least one optical fiber abuts said flat bottom.

11. A method as recited in claim 4, wherein said pits each have sidewalls and said sidewalls guide said at least one optical fiber into position.

12. A method as recited in claim 7, wherein said pitch has an accuracy of in the range of approximately 0.5 μm to approximately 3.0 μm.

13. A method as recited in claim 1, wherein said securing of said at least one optical fiber in said tool is effected with optical grade epoxy.

14. A method as recited in claim 1, wherein said securing of said at least one optical fiber in said tool is effected with solder.

15. A method as recited in claim 7, wherein said first array of optical fibers and said second array of optical fibers have endfaces which are substantially coplanar.

16. An optical fiber array, comprising:
A plurality of optical fibers having endfaces disposed in a tool, said endfaces being exposed; and
said plurality of optical fibers having a pitch which has a tolerance in a range of approximately 0.5 μm to approximately 3.0 μm.

17. An optical fiber array as recited in claim 16, wherein said endfaces are substantially co-planar.

18. An optical fiber array as recited in claim 16, wherein said pitch is in the range of approximately 150 μm to approximately 1000 μm.

19. An optical fiber array as recited in claim 16, wherein said tool has a plurality of pits, and each of said pits receives one of said optical fibers.

20. An optical fiber array as recited in claim 17, wherein said plurality of optical fibers are connected to an optical element chosen from the group consisting essentially of lenses, switches and micro-electro-mechanical (MEM's) devices.

21. An optical fiber array as recited in claim 16, wherein said range is approximately 0.5 μm to less than approximately 1.0 μm.
